(19) United States
(12) Patent Application Publication
(10) Pub. No.: US 2024/0327562 A1
(43) Pub. Date: Oct. 3, 2024

(54) ALKYLPHENOL-ALDEHYDE RESINS WITH A NATURAL ALDEHYDE COMPONENT FOR USE IN OILFIELD APPLICATIONS

(71) Applicant: ChampionX LLC, Sugar Land, TX (US)

(72) Inventors: Izabela Anita Owsik, College Station, TX (US); Keith Allen Monk, New Braunfels, TX (US); Chad Michael Gilmer, Richmond, TX (US)

(21) Appl. No.: 18/616,862

(22) Filed: Mar. 26, 2024

Related U.S. Application Data
(60) Provisional application No. 63/493,624, filed on Mar. 31, 2023.

(51) Int. Cl. C08G 8/04

(52) U.S. Cl. CPC C08G 8/04

(57) ABSTRACT

Alkylphenol-aldehyde resins and alkoxy alkylphenol-aldehyde resins that have a natural aldehyde component for use in oilfield applications. A method for synthesizing an alkylphenol-aldehyde resin having a natural aldehyde component, a method for synthesizing an alkoxy alkylphenol-aldehyde resin having a natural aldehyde component, and methods for asphaltene inhibition, viscosity reduction, and emulsion breaking using the disclosed resins.

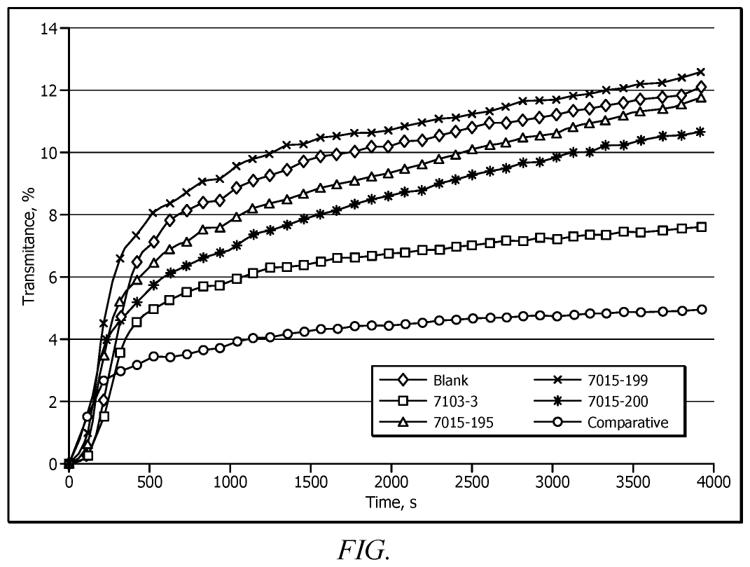

### CROSS-REFERENCE TO RELATED APPLICATIONS

This application claims the benefit of and priority to U.S. Provisional Patent Application No. 63/493,624, filed on Mar. 31, 2023, and entitled “Alkylphenol-Aldehyde Resins with a Natural Aldehyde Component for use in Oilfield Applications,” which is incorporated by reference in its entirety.

### FIELD OF THE DISCLOSURE

The present disclosure generally relates to alkylphenol-aldehyde resins and alkoxy alkylphenol-aldehyde resins made from renewable sources, to the synthesis of these resins, and to the use of these resins in oilfield applications.

### BACKGROUND

Many challenges arise in the production, transportation, and refining of crude, and some challenges can be addressed via the use of asphaltene inhibitors, viscosity reducers, and emulsion breakers.

Asphaltene inhibitors can be added to a crude oil to control the formation of problematic solids called asphaltenes. Asphaltenes are highly prevalent in heavy and extra-heavy crude oils, and asphaltene deposits can block reservoir pores in near-well formations, production tubing, and downstream pipelines. For crude oils over a range of API gravities, asphaltenes can be stable under virgin reservoir conditions, but can be destabilized and precipitate from crude oil during production due to changes in temperature, pressure, chemical composition, and shear rate. Asphaltene deposits can occur throughout the production system, from inside the reservoir formation to pumps, tubing, wellheads, safety valves, flow lines, and surface facilities used in the extraction process. Asphaltene deposits can cause production rate decline and other operational problems, such as increased fluid viscosity and density, and stabilization of oil-water emulsions. Chemical additives, such as dispersants and inhibitors, can be added to the crude oil to control asphaltene deposition. Asphaltene inhibitors, for example, can be engineered to shift asphaltene flocculation pressure and prevent aggregation of asphaltene molecules. However, asphaltene inhibitors can be synthesized from chemical compounds that are sourced from fossil fuels.

Viscosity reducers can be added to a crude oil to decrease the oil viscosity and improve flowability of a crude oil through production tubing, pipes, equipment, and vessels. The viscosity of the oil, especially at low temperatures, can be a challenge for production and transportation of the oil. Diluents can be added to the oil to reduce the viscosity, such as a light crude oil or natural gas condensate. Alternatively, the operating and transportation temperatures can be increased to maintain the liquid state of the crude oil. Another way of reducing viscosity is through the addition of a viscosity reducer, such as alkylphenol-aldehyde resins, e.g., a nonylphenol-paraformaldehyde resin. While alkylphenol-aldehyde resins can adequately reduce viscosity in many situation, alkylphenol-aldehyde resins are typically synthesized from synthetic compounds obtained from fossil fuels.

Emulsion breakers can be added to a crude oil to address water/oil (oil-in-water or water-in-oil) emulsions that may be present when water is produced with the oil. In addition to oil and water, produced fluid can contain water soluble salts, such as sodium chloride, magnesium and calcium chlorides, sulfates, and other such salts, insoluble salts and other solids, both inorganic and organic. To use the crude oil, such as for refining, the oil can be separated from the water and salts. For example, water can be removed from crude oil in a desalting unit. Demulsifiers, also referred to as emulsion breakers, can be added to the oil and water emulsion to assist in the desalting process. However, demulsifiers can be synthesized from synthetic compounds obtained from fossil fuels.

Because asphaltene inhibitors, viscosity reducers, and demulsifiers/emulsion breakers are often derived from fossil fuels, there is a need to find alternative asphaltene inhibitors, viscosity reducers, and demulsifiers/emulsion breakers that are derived from renewable components and sources.

### SUMMARY

Disclosed is an alkylphenol-aldehyde resin including: an alkylphenol component; and an aldehyde component, wherein the aldehyde component includes i) a natural aldehyde component and optionally ii) a paraformaldehyde component.

Disclosed is an alkoxy alkylphenol-aldehyde resin, including: an alkylphenol component; an aldehyde component, wherein the aldehyde component includes i) a natural aldehyde component and optionally ii) a paraformaldehyde component; and an alkoxy component.

Disclosed is a method for synthesizing an alkylphenol-aldehyde resin, the method including reacting an alkylphenol compound with a natural aldehyde compound to produce the alkylphenol-aldehyde resin.

Disclosed is a method for synthesizing an alkoxy alkylphenol-aldehyde resin, the method including reacting an alkylphenol compound with a natural aldehyde compound to produce the alkylphenol-aldehyde resin, and reacting the alkylphenol-aldehyde resin with an alkoxy compound to form an alkoxy alkylphenol-aldehyde resin.

Disclosed is a method for asphaltene inhibition, that can include contacting a hydrocarbon fluid with an asphaltene inhibitor that includes an alkylphenol-aldehyde resin disclosed herein.

Disclosed is a method for reducing viscosity of a hydrocarbon fluid, that can include contacting the hydrocarbon fluid with a viscosity reducer that includes an alkylphenol-aldehyde resin disclosed herein.

Disclosed is a method of breaking an emulsion in a produced fluid. The method can include contacting an emulsion breaker with the produced fluid, where the emulsion breaker includes the an alkoxy alkylphenol-aldehyde resin disclosed herein.

Other technical features may be readily apparent to one skilled in the art from the following FIGURES, descriptions, and claims.

### BRIEF DESCRIPTION OF THE DRAWINGS

For a more complete understanding of this disclosure, reference is now made to the following description, taken in conjunction with the accompanying drawings, in which:

The FIG. is a graph of asphaltene inhibition versus time for several resins as described herein.

### DETAILED DESCRIPTION

“Produced fluid” as used herein includes hydrocarbons, water, water soluble salts, solids (e.g., sand, rock fragments), or combinations thereof that are produced from a subterranean formation according to any technique known in the art with the aid of this disclosure. A produced fluid can be embodied as a fluid having most solids removed, e.g., via a plug catcher. A produced fluid disclosed herein can contain hydrocarbons in a liquid phase, a gas phase, or both the liquid phase and gas phase.

“Hydrocarbon fluid” as used herein includes a produced fluid or a fluid that is obtained after processing or treating a produced fluid, for example, by processing or treating to remove solids and/or water from the hydrocarbons contained in the produced fluid.

“Natural” or “renewable” when used herein with aldehyde, aldehyde compound, and aldehyde component means that the aldehyde, aldehyde compound, or aldehyde component is derived from a renewable source such as a plant.

“Natural” or “renewable” when used herein to refer to a resin means that the resin includes a natural or renewable aldehyde component.

“Synthetic” when used herein with aldehyde, aldehyde compound, and aldehyde component means that the aldehyde, aldehyde compound, or aldehyde component is derived from a nonrenewable source, such as a fossil fuel.

### Resins

Disclosed herein are renewable alkylphenol-aldehyde resins and renewable alkoxy alkylphenol-aldehyde resins that include an alkylphenol component and a natural aldehyde component. The alkylphenol-aldehyde resins can additionally include a synthetic aldehyde component. The alkoxy alkylphenol-aldehyde resins additionally include an alkoxy component and can optionally include a synthetic aldehyde component.

The alkylphenol-aldehyde resin can be synthesized by one or more steps that can include reacting an alkylphenol compound with a natural aldehyde compound and optionally with a synthetic aldehyde component. When the renewable alkylphenol-aldehyde resin is synthesized with a natural aldehyde component and a synthetic aldehyde compound, i) the alkylphenol compound can be reacted with the natural aldehyde compound, ii) the alkylphenol compound can be reacted with the natural aldehyde compound and then the synthetic aldehyde compound, iii) the alkylphenol compound can be reacted with the synthetic aldehyde compound and then the natural aldehyde compound and then the synthetic aldehyde compound, iv) a reaction mixture produced by the reaction of the alkylphenol compound and the natural aldehyde compound can be reacted with the synthetic aldehyde compound, v) a reaction mixture produced by the reaction of the alkylphenol compound and the synthetic aldehyde compound can be reacted with the natural aldehyde compound, or combinations of i)-v), to produce the renewable alkylphenol-aldehyde resin. An alkylphenol-aldehyde resin can be further reacted with an alkoxy compound to produce an alkoxy alkylphenol-aldehyde resin disclosed herein.

By incorporating a natural aldehyde component into the resins disclosed herein, the aldehyde component of a resin that would otherwise be made up of a synthetic aldehyde component may be made partially or entirely of a natural aldehyde component. The incorporation of natural aldehyde component into a resin disclosed herein thus shifts the resins into a renewable category of resins because at least part of the aldehyde component, or all of the aldehyde component, is derived from a renewable source. This may be contrasted with synthetic aldehydes, such as paraformaldehyde, which are derived from fossil fuels. Incorporation of a natural aldehyde into the resin also allows for increased aromaticity, hydrophilicity, and branching of the resulting resin. For example, increased aromaticity can be beneficial for inhibiting asphaltenes which have a high degree of aromaticity.

The alkylphenol-aldehyde resins containing a natural aldehyde component are useful in oilfield applications such as asphaltene inhibition and viscosity reduction. When such resins are further functionalized with an alkylene oxide to produce an alkoxy alkylphenol-aldehyde resin, the alkoxy alkylphenol-aldehyde resin is useful in oilfield applications such as emulsion breaking.

An alkylphenol compound is used to form the alkylphenol component of the disclosed resins. The alkylphenol compound includes one or more alkyl groups bonded to the ortho, meta, and/or para positions on the phenol ring. In one aspect, one alkyl group is bonded to the phenol ring. In another aspect two, three, or our alkyl groups can be bonded to the phenol ring. Non-limiting examples of alkyl groups includes straight or branched chain C₄-C₁₈ alkyl groups; alternatively, straight or branched chain C₆-C₁₄ alkyl groups. A particular non-limiting group of suitable alkylphenol compounds is represented by the following formula:

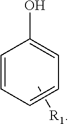

where R₁ is a straight or branched chain C₄-C₁₈ alkyl group attached to the phenol ring at the ortho, meta, or para position. In one aspect, the alkylphenol compound is represented by the following formula in which R₁ is attached to the phenol ring at the para position:

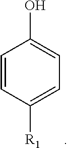

A non-limiting list of alkylphenol compounds includes methylphenol, tert-butylphenol (PTBP), sec-butylphenol, amyl phenol, tert-hexylphenol, amylphenol, cyclohexylphenol, octyl phenol, isooctylphenol, tert-octylphenol (PTOP), nonylphenol, decylphenol, dodecylphenol, tetradecyl phenol, pentadecylphenol, cetylphenol, octadecylphenol, dinonylphenol, or combinations thereof.

A natural aldehyde compound is used to form the natural aldehyde component of the disclosed resins. Examples of natural aldehyde compounds include vanillin, cinnamaldehyde, and furfural.

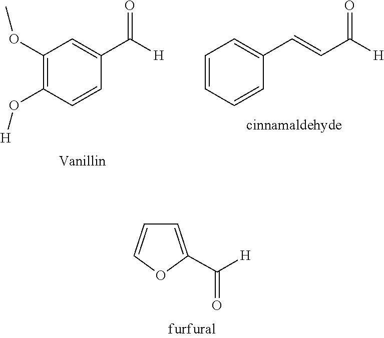

While the natural aldehyde compound may be obtained from any of a number of ways known in the art, in one aspect, the natural aldehyde compound may be obtained through purification of a natural source of the aldehyde. For example, when the natural aldehyde compound includes vanillin, vanillin may be purified from vanilla beans. In another example, when the natural aldehyde compound includes trans-cinnamaldehyde, trans-cinnamaldehyde may be purified from sources including the bark of cinnamon trees or other species of the genus Cinnamomum, such as camphor and cassia. In yet another example, when the natural aldehyde compound includes furfural, furfural may be purified from sources including lignocellulosic biomass (such as sawdust), sugarcane bagasse, oat hulls, wheat bran, or corn cobs. In another aspect, the natural aldehyde compound may be obtained by synthesis from a non-aldehyde starting compound that is obtained through purification of a natural source of the aldehyde. For example, vanillin may be microbially biosynthesized from ferulic acid that is extracted from rice bran. In another example, furfural may be synthesized through acid catalyzed dehydration of 5-carbon sugars that are produced from pentosans that have been obtained from hemicellulose present in lignocellulosic biomass.

A synthetic aldehyde compound is used to form the synthetic aldehyde component of the disclosed resins that contain synthetic aldehyde component. The optional synthetic aldehyde compound can be synthesized in a laboratory or other industrial environment. In aspects, the synthetic aldehyde compound is not purified from an organic source. For example, the synthetic aldehyde compound can be derived from fossil fuels, such as petroleum extracted from a subterranean formation. An example of a synthetic aldehyde compound is polyoxymethylene (also informally known as paraformaldehyde), the structure for which is illustrated below:

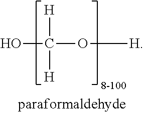

In aspects, the molar ratio of the alkylphenol component to the natural aldehyde component in any of the resins disclosed herein may range from 0.5:1 to 2:1, from 0.5:1 to 1.5:1, as well as from 2.0:1 to 1:1. In aspects, the molar ratio of the alkylphenol component to the aldehyde components (the total moles of the natural aldehyde component(s) and the synthetic aldehyde component) in the alkylphenol-aldehyde resin may range from 0.5:1 to 2:1, from 0.5:1 to 1.5:1, as well as from 2.0:1 to 1:1.

In aspects, any of the resins disclosed herein can have from 0 wt % to 99 wt % of the synthetic aldehyde component and from 1 wt % to 100 wt % of the natural aldehyde component based on a total weight of the synthetic aldehyde component and the natural aldehyde component in the resin.

In aspects, the alkylphenol-aldehyde resin can have a Mn in a range of from about 500 Da to 2500 Da, a Mw in a range of from about 500 Da to about 5200 Da, and a Mz in a range of from about 2600 Da to 9000 Da. In some aspects, the alkylphenol-aldehyde resin can have a Mn in a range of from about 500 Da to 2500 Da, a Mw in a range of from about 2000 Da to about 4500 Da, and a Mz in a range of from about 2600 Da to 9000 Da

In aspects, the alkylphenol-aldehyde resin can have a Mn:Mw ratio (also referred to as a polydispersity index (PDI)) in a range of from 1.1 to 2.0.

In some aspects, the alkylphenol-aldehyde resin includes or consists of a nonylphenol component and a vanillin, cinnamaldehyde, and/or furfural component. In some aspects, the alkylphenol-aldehyde resin includes or consists of a nonylphenol component, a paraformaldehyde component, and a vanillin, cinnamaldehyde, and/or furfural component.

In aspects, the alkoxy component of the alkoxy alkylphenol-aldehyde resins disclosed herein can be an ethoxy group, a propoxy group, or a butoxy group. The alkoxy compound from which the alkoxy component is formed can be ethylene oxide, propylene oxide, butene oxide, or combinations thereof.

In aspects, a degree of alkoxylation of an alkoxy alkylphenol-aldehyde resin disclosed herein can be from 1 wt % to 45 wt % based on a total weight of the alkoxy component divided by a total weight of the alkylphenol component in the alkoxy alkylphenol-aldehyde resin. In additional or alternative aspects, a degree of alkoxylation of an alkoxy alkylphenol-aldehyde resin disclosed herein can be from 1 mol % to 100%, alternatively, from 20 mol % to 87 mol %, alternatively, from 25 mol % to 35 mol % based on a total moles of the alkoxy component divided by a total moles of the alkylphenol component in the alkoxy alkylphenol-aldehyde resin.

### Methods

The methods involve reacting an alkylphenol compound with a natural aldehyde compound and optionally with a synthetic aldehyde compound. Reacting can be performed in any number of sequential steps, such as 1) reacting the alkylphenol compound with a natural aldehyde compound to form the alkylphenol-aldehyde resin, 2) reacting the alkylphenol compound with a natural aldehyde compound to form a first portion of the alkylphenol-aldehyde resin and then reacting the alkylphenol compound with a synthetic aldehyde to form a second portion of the alkylphenol-aldehyde resin, 3) reacting the alkylphenol compound with a synthetic aldehyde compound to form a first portion of the alkylphenol-aldehyde resin then reacting the alkylphenol compound with a natural aldehyde to form a second portion of the alkylphenol-aldehyde resin and then reacting the alkylphenol compound with a synthetic aldehyde compound to form a third portion of the alkylphenol-aldehyde resin, or 3) repeating step 1), 2), or 3) any number of times to form any number of portions of the alkylphenol-aldehyde resin.

In aspects, reacting aldehydes can occur in sequential steps. Reacting in sequential steps may include reacting an alkylphenol-aldehyde resin intermediate (resulting from prior reaction of the alkylphenol compound and the previously added aldehyde compound) and the subsequently added aldehyde compound and/or the reaction of unreacted amounts of the alkylphenol compound with the aldehyde compound. That is, reacting the subsequently added aldehyde compound can form resin blocks.

Alternatively, reacting aldehydes can occur in concurrent steps. Reacting in concurrent steps (e.g., mixing in the same point in time) may include reacting a mixture of the aldehyde(s) which form the resin through relative reactivity.

In a first method, the alkylphenol-aldehyde resins are synthesized by reacting an amount of an alkylphenol compound with an amount of a natural aldehyde compound. In aspects, the first method does not include reacting an amount of the alkylphenol compound with a synthetic aldehyde compound. The resin produced by the first method includes an alkylphenol component and a natural aldehyde component. By “including an alkylphenol component” we mean that the alkylphenol-aldehyde resin includes monomeric units that result from the chemical reaction between the amount of the alkylphenol compound and the amount of the natural aldehyde compound and whose structure is derived from the structure of the alkylphenol molecule. Similarly, by “including a natural aldehyde component”, we mean that the alkylphenol-aldehyde resin includes monomeric units that result from the chemical reaction between the amount of the alkylphenol compound and the amount of the natural aldehyde compound and whose structure is derived from the structure of the natural aldehyde molecule.

The alkylphenol-aldehyde resins synthesized according to the first method include individual units of the alkylphenol component that alternate with units of the natural aldehyde component, with the proviso that each of the units of the natural aldehyde component need not be the same. For example, each of the units of the natural aldehyde component may be the same. In other examples, the alkylphenol-aldehyde resin may include: units of a vanillin component and units of a cinnamaldehyde component; units of a vanillin component and units of a furfural component; units of a cinnamaldehyde component and units of a furfural component; or units of a vanillin component, a cinnamaldehyde component, and a furfural component. In addition, the alkylphenol-aldehyde resin may alternatively include units of only a single type of natural aldehyde component, such as only a vanillin component, only a cinnamaldehyde component, or only a furfural component.

In aspects, the first method may be carried out through reaction of the alkylphenol compound with a natural aldehyde compound, and in these variations, reactions may be carried out sequentially through reaction of the alkylphenol compound with a first amount of the natural aldehyde compound to produce a reaction mixture and subsequently reacting the reaction mixture with another amount of the natural aldehyde compound.

In aspects, the first method may be carried out through reaction of the alkylphenol compound with a mixture of natural aldehyde compounds, and in these variations, reactions may be carried out sequentially through reaction of the alkylphenol compound with one particular natural aldehyde compound to produce a reaction mixture and subsequently reacting the reaction mixture with another (different) particular natural aldehyde compound, and optionally subsequently reacting the reaction mixture (produced from the reaction of the reaction mixture with the second particular natural aldehyde compound) with yet another (different) particular natural aldehyde compound.

In the first method, the molar ratio of the alkylphenol compound to the natural aldehyde compound(s) may range from 0.5:1 to 2:1, from 0.5:1 to 1.5:1, as well as from 2.0:1 to 1:1. Similarly, the molar ratio of the alkylphenol component to the natural aldehyde component(s) in the alkylphenol-aldehyde resin may range from 0.5:1 to 2:1, from 0.5:1 to 1.5:1, as well as from 2.0:1 to 1:1.

After addition of the alkylphenol compound and the natural aldehyde compound(s) to the reaction vessel, the reaction mixture in the reaction vessel may be heated to a first temperature. In aspects, a catalyst can then be added to the reaction mixture. If the temperature of the reaction mixture subsequently rises above a desired or predetermined temperature, the reaction mixture may be allowed to cool until reaching a second temperature. Optionally, second or third reactions of the reaction mixture with other additions of natural aldehyde compound(s) may be performed as described above. After all amounts of the natural aldehyde compound(s) is reacted, the temperature of the contents of the reaction vessel may be ramped up to an initial (low) hold temperature and held for a first period sufficient to remove water. If desired, the temperature may be subsequently ramped up to a subsequent (high) hold temperature and held for a second period. The first temperature and second temperature can each independently be in a range of 60° C. to 99° C. (140° F. to 210° F.); alternatively, from 60° C. to 65° C. (140° F. to 150° F.); alternatively, from 65° C. to 99° C. (150° F. to 210° F.); alternatively, about 65° C. In aspects, the first temperature and second temperature can be the same temperature. The first (low) hold temperature can be in a range of from 93.3° C. to 177° C. (200° F. to 350° F.); alternatively, from 93.3° C. to 99° C. (200° F. to 210° F.); alternatively, about 95° C. The first period can be in a range of from 1 hr to 4 hr; alternatively, from 1 hr to 2 hr. The second (high) hold temperature can be in a range of from 171° C. to 227° C. (340° F. to 440° F.); alternatively, from 180° C. to 227° C. (356° F. to 440° F.); alternatively, from 171° C. to 188° C. (340° F. to 370° F.); alternatively, from 176.6° C. to 182.2° C. (350° F. to 360° F.). The second period can be in a range of from 1.0 hr to 5.0 hr; alternatively, from 1.5 hr to 3.5 hr; alternatively from 1.0 hr to 3.0 hr. The upper endpoint of the high hold temperature can be higher than 227° C. and determined based on the amount of the natural aldehyde and reactivity. Once the contents have been held at the desired hold temperature for the desired amount of time, the contents may be allowed to cool, and the alkylphenol-aldehyde resin recovered and optionally further purified.

In a second method, the method results in an alkylphenol-aldehyde resin that includes an alkylphenol component, a natural aldehyde component, and a synthetic aldehyde component.

In one variation of this second method, the synthesis of the alkylphenol-aldehyde resin is carried out in a first step by reacting an amount of an alkylphenol compound with a first amount of a synthetic aldehyde compound (such as paraformaldehyde) to produce a reaction mixture. This first reaction mixture is subsequently reacted in a second step with an amount of the natural aldehyde compound. This second reaction mixture is subsequently reacted in a third step with a second amount of the synthetic aldehyde resin. The second step and third step can be repeated in sequence so that the synthetic aldehyde is the last aldehyde added.

In performance of the above-described variation, after addition of the alkylphenol and synthetic aldehyde compounds to the reaction vessel, the reaction mixture in the reaction vessel may be heated to a first temperature. In aspects, a catalyst can then be added to the reaction mixture. If the temperature of the reaction mixture subsequently rises above a desired or predetermined temperature, the reaction mixture may be allowed to cool until reaching a second temperature. The natural aldehyde compound(s) are subsequently added to the reaction vessel. Again, if the temperature rises above a desired or predetermined temperature, the reaction mixture may be allowed to cool to a third temperature. An additional amount of the synthetic aldehyde may be added to the reaction mixture as described above, and the optional cooling step may be carried out. After all amounts of the synthetic aldehyde compound and the natural aldehyde compound(s) are reacted, the temperature of the contents of the reaction vessel may be ramped up to an initial (low) hold temperature and held for a first period sufficient to remove water. If desired, the temperature may be subsequently ramped up to a subsequent (high) hold temperature and held for a second period. The first temperature, second temperature, and third temperature can each independently be in a range of 60° C. to 99° C. (140° F. to 210° F.); alternatively, from 60° C. to 65° C. (140° F. to 150° F.); alternatively, from 65° C. to 99° C. (150° F. to 210° F.); alternatively, about 65° C. In aspects, the first temperature, second temperature, and third temperature can be the same temperature. The first (low) hold temperature can be in a range of from 93.3° C. to 177° C. (200° F. to 350° F.); alternatively, from 93.3° C. to 99° C. (200° F. to 210° F.); alternatively, about 95° C. The first period can be in a range of from 1 hr to 4 hr; alternatively, from 1 hr to 2 hr. The second (high) hold temperature can be in a range of from 171° C. to 227° C. (340° F. to 440° F.); alternatively, from 180° C. to 227° C. (356° F. to 440° F.); alternatively, from 171° C. to 188° C. (340° F. to 370° F.); alternatively, from 176.6° C. to 182.2° C. (350° F. to 360° F.). The second period can be in a range of from 1.0 hr to 5.0 hr; alternatively, from 1.5 hr to 3.5 hr; alternatively from 1.0 hr to 3.0 hr. The upper endpoint of the high hold temperature can be higher than 227° C. and determined based on the amount of the natural aldehyde and synthetic aldehyde, and the respective aldehyde reactivities. Once the contents have been held at the desired hold temperature for the desired amount of time, the contents may be allowed to cool, and the alkylphenol-aldehyde resin recovered and optionally further purified.

In another variation of this second method, the synthesis of the alkylphenol-aldehyde resin is carried out in a first step by reacting an amount of an alkylphenol compound with an amount of the natural aldehyde compound to produce a reaction mixture. This reaction mixture is subsequently reacted in a second step with an amount of the synthetic aldehyde compound (such as paraformaldehyde). The second step may be repeated any number of times.

Regardless of which of the variations of the second method is utilized, the natural aldehyde and the synthetic aldehyde may be added in any order, with the proviso that the synthetic aldehyde is added last. It is contemplated that there is no limit to the number of alternating additions of natural aldehyde and synthetic aldehyde (or additions of synthetic aldehyde and natural aldehyde) that may be performed during the synthetic method.

In performance of the above-described other variation, after addition of the alkylphenol and natural aldehyde compound(s) to the reaction vessel, the reaction mixture in the reaction vessel may be heated to a first temperature. In aspects, a catalyst can then be added to the reaction mixture. If the temperature of the reaction mixture subsequently rises above a desired or predetermined temperature, the reaction mixture may be allowed to cool until reaching a second temperature. The synthetic aldehyde compound is subsequently added to the reaction vessel. Again, if the temperature rises above a desired or predetermined temperature, the reaction mixture may be allowed to cool until reaching a third temperature. Optionally, additional amounts of the synthetic aldehyde and/or natural aldehyde compound may be subsequently added to the reaction mixture as described above, and the optional cooling step may be carried out. For example, because paraformaldehyde reacts faster than at least some of the natural aldehydes, and produces an associated exotherm, the reaction with the paraformaldehyde may be carried out in two or more separate additions of paraformaldehyde, optionally allowing the reaction vessel contents to cool in between additions/reactions. After all amounts of the synthetic aldehyde compound and the natural aldehyde compound(s) are reacted, the temperature of the contents of the reaction vessel may be ramped up to a first (low) hold temperature and held for a first period sufficient to remove water. If desired, the temperature may be subsequently ramped up to a second (high) hold temperature and held for a second period. Once the contents have been held at the desired hold temperature for the desired amount of time, the contents may be allowed to cool, and the synthesized alkylphenol-aldehyde resin recovered and optionally further purified. The first temperature, second temperature, and third temperature can each independently be in a range of 60° C. to 99° C. (140° F. to 210° F.); alternatively, from 60° C. to 65° C. (140° F. to 150° F.); alternatively, from 65° C. to 99° C. (150° F. to 210° F.); alternatively, about 65° C. In aspects, the first temperature, second temperature, and third temperature can be the same temperature. The first (low) hold temperature can be in a range of from 93.3° C. to 177° C. (200° F. to 350° F.); alternatively, from 93.3° C. to 99° C. (200° F. to 210° F.); alternatively, about 95° C. The first period can be in a range of from 1 hr to 4 hr; alternatively, from 1 hr to 2 hr. The second (high) hold temperature can be in a range of from 171° C. to 227° C. (340° F. to 440° F.); alternatively, from 180° C. to 227° C. (356° F. to 440° F.); alternatively, from 171° C. to 188° C. (340° F. to 370° F.); alternatively, from 176.6° C. to 182.2° C. (350° F. to 360° F.). The second period can be in a range of from 1.0 hr to 5.0 hr; alternatively, from 1.5 hr to 3.5 hr; alternatively from 1.0 hr to 3.0 hr.

Regardless of the variation utilized, for alkylphenol-aldehyde resins synthesized according to the second method, the weight percentages of the synthetic aldehyde compound (such as paraformaldehyde) and the natural aldehyde compound (based upon the total weight of the synthetic aldehyde compound and the natural aldehyde compound reacted) ranges between 0-99 wt % of the synthetic aldehyde compound and 1-100 wt % of the natural aldehyde compound based on a total weight of the synthetic aldehyde compound and the natural aldehyde compound used in the methods. Also, the weight percentages of the synthetic aldehyde component (resulting from reaction of the alkylphenol compound and a synthetic aldehyde such as paraformaldehyde) and the natural aldehyde component (based upon the total weight of the synthetic aldehyde component and the natural aldehyde component) ranges between 0-99 wt % of the synthetic aldehyde component and 1-100 wt % of the natural aldehyde component.

In the second method, the molar ratio of the alkylphenol compound to the aldehyde compounds (the total of the natural aldehyde compound(s) and the synthetic aldehyde compound) may range from 0.5:1 to 2:1, from 0.5:1 to 1.5:1, as well as from 2.0:1 to 1:1. Similarly, the molar ratio of the alkylphenol component to the aldehyde components (the total of the natural aldehyde component(s) and the synthetic aldehyde component) in the alkylphenol-aldehyde resin may range from 0.5:1 to 2:1, from 0.5:1 to 1.5:1, as well as from 2.0:1 to 1:1.

Regardless of whether the first or the second synthesis method is utilized, if the method includes two or three separate reactions, the reaction mixture in between steps may be allowed to cool in case the prior reaction is relatively exothermic and raises the temperature of the reaction mixture beyond a desired or predetermined temperature.

While the alkylphenol-aldehyde resins are suitable for use in any known compositions, processes or products involving alkylphenol-aldehyde resins, we will now discuss particular uses of the alkylphenol-aldehyde resins.

In a first particular use, the alkylphenol-aldehyde resins are especially suitable for use in viscosity reducers or asphaltene inhibitors.

A method of reducing viscosity includes a step of contacting a hydrocarbon with a viscosity reduction composition that includes the alkylphenol-aldehyde resin.

A viscosity reduction composition includes an amount of the alkylphenol-aldehyde resin. It may further include an amount of the alkoxy alkylphenol-aldehyde resin, an alkoxy trimethylolpropane, an alkoxy poly(bisphenol A diglycidyl ether), a nonyl phenyl polyetheramine, an ethoxylated tallow diamine, an ethoxylated tallow amine, a polyisobutylene succinic anhydride pentaerithrytol diester, a reaction product of α-olefin, maleic anhydride and pentaerithrytol, dodecyl benzene sulfonic acid, or a combination thereof.

The viscosity reduction composition can further comprise a solvent and the solvent can be a xylene-containing asphaltene solvent, a limonene-containing asphaltene solvent, an aromatic solvent, an alcohol, or a combination thereof.

The crude oil can be heavy or extra-heavy and can have an API gravity of from about 5 to about 20; from about 5 to about 19; from about 5 to about 18; from about 5 to about 17; from about 5 to about 16; from about 6 to about 20; from about 6 to about 19; from about 6 to about 18; from about 6 to about 17; from about 6 to about 18; from about 6 to about 17; or from about 6 to about 16.

The viscosity reduction composition can reduce the size of the asphaltene aggregates or hinder their formation.

The viscosity reduction composition may include a solvent of an aromatic solvent, an alcohol, or a combination thereof. The aromatic solvent can comprise a heavy aromatic naphtha, toluene, xylene, light diesel, quinoline, or a combination thereof. The alcohol can comprise ethylene glycol monobutyl ether, a linear or branched C₂-C₈ alcohol, or a combination thereof.

The viscosity reduction composition may be added to the crude oil at a concentration from about 50 ppm to about 15000 ppm, from about 50 ppm to about 10000 ppm, from about 50 ppm to about 9000 ppm, from about 50 ppm to about 8000 ppm, from about 50 ppm to about 7000 ppm, from about 50 ppm to about 6000 ppm, from about 50 ppm to about 5000 ppm, from about 50 ppm to about 4000 ppm, from about 50 ppm to about 3000 ppm, from about 50 ppm to about 2000 ppm, from about 50 ppm to about 1000 ppm, from about 75 ppm to about 15000 ppm, from about 75 ppm to about 10000 ppm, from about 75 ppm to about 9000 ppm, from about 75 ppm to about 8000 ppm, from about 75 ppm to about 7000 ppm, from about 75 ppm to about 6000 ppm, from about 75 ppm to about 5000 ppm, from about 75 ppm to about 4000 ppm, from about 75 ppm to about 3000 ppm, from about 75 ppm to about 2000 ppm, from about 75 ppm to about 1000 ppm, from about 100 ppm to about 15000 ppm, from about 100 ppm to about 10000 ppm, from about 100 ppm to about 9000 ppm, from about 100 ppm to about 8000 ppm, from about 100 ppm to about 7000 ppm, from about 100 ppm to about 6000 ppm, from about 100 ppm to about 5000 ppm, from about 100 ppm to about 4000 ppm, from about 100 ppm to about 3000 ppm, from about 100 ppm to about 2000 ppm, or from about 100 ppm to about 1000 ppm based on a total weight of the crude oil.

In aspects, the viscosity reduction composition can be added to the crude oil at a concentration from about 100 ppm to about 1000 ppm based on a total weight of the crude oil.

The viscosity reducing composition may further include one or more additional components including but not limited to a corrosion inhibitor, a solvent, an additional asphaltene inhibitor, a paraffin inhibitor, a scale inhibitor, an emulsifier, a dispersant, an emulsion breaker, a gas hydrate inhibitor, a biocide, a pH modifier, and a surfactant in amounts and of types disclosed herein. The viscosity reducing composition may include about 0-10 wt % of one or more of these additional components, based on total weight of the viscosity reducing composition.

In a second particular use, the alkylphenol-aldehyde resins may be used in an asphaltene inhibiting composition. A method of inhibiting asphaltene includes a step of contacting an asphaltene-containing hydrocarbon composition with an asphaltene inhibiting composition that includes the alkylphenol-aldehyde resin.

Asphaltene deposition can occur onto any surface involved in the production, extraction and/or refinement of crude oil. For example, the surface can comprise a formation, a pump, a tube, a wellhead, a valve (e.g., safety valve), a flow line, and/or a surface facility used in extraction. Asphaltene precipitation can be caused by a number of factors including changes in pressure, temperature, and composition. Frequently asphaltene precipitation is induced when pressures inside the reservoir decrease and/or oil is mixed with injected solvent (e.g., in improved oil recovery processes), or blending with a highly paraffinic material. Other processes that can induce precipitation in the near wellbore region include drilling, completion, acid stimulation, and hydraulic fracturing activities.

An asphaltene inhibiting composition can be administered in several ways. The composition can be used alone or blended with additional asphaltene dispersants. The composition may include active ingredients in the following concentrations: about 1-100 wt %, about 1-90 wt %, about 1-80 wt %, about 1-70 wt %, about 1-60 wt %, about 1-50 wt %, about 5-100 wt %, about 5-90 wt %, about 5-80 wt %, about 5-70 wt %, about 5-60 wt %, about 5-50 wt %, about 10-100 wt %, about 10-90 wt %, about 10-80 wt %, about 10-70 wt %, about 10-60 wt %, or about 10-50 wt %.

In particular, the asphaltene-inhibiting composition can comprise from about 10 wt % to about 90 wt % of the alkylphenol-aldehyde resin with the balance of the composition being a hydrophobic solvent.

The hydrophobic solvent can comprise toluene, xylene, an ethylbenzene, an aromatic naphtha, a produced hydrocarbon, diesel, kerosene, or a combination thereof.

An effective amount of the asphaltene-inhibiting composition can be from about 1 ppm to about 1000 ppm of the alkylphenol-aldehyde resin based on a total weight of a fluid containing the asphaltene-containing hydrocarbon with which it is contacted. In aspects, the effective amount is present in the following ranges: about 1-900 ppm, about 1-800 ppm, about 1-700 ppm, about 1-600 ppm, or about 1-500 ppm based on a total weight of a fluid containing the asphaltene-containing hydrocarbon with which it is contacted. Further, the effective amount of the alkylphenol-aldehyde resin can be from about 1-250 ppm, about 1-200 ppm, or about 1-100 ppm based on a total weight of a fluid containing the asphaltene-containing hydrocarbon with which it is contacted.

The asphaltene-inhibiting composition may include an effective amount of the alkylphenol-aldehyde resin and a component selected from the group consisting of a corrosion inhibitor, an organic solvent, an asphaltene inhibitor, a paraffin inhibitor, a scale inhibitor, an emulsifier, a water clarifier, a dispersant, an emulsion breaker, a reverse emulsion breaker, a gas hydrate inhibitor, a biocide, a pH modifier, a surfactant, and a combinations thereof in amounts and types disclosed herein.

In a third particular use, the alkoxy alkylphenol-aldehyde resins are also especially suitable for use in emulsion breakers. Such alkoxy alkylphenol-aldehyde resins may be produced by replacing some or all of the hydroxyl groups on the phenol rings of the synthesized alkylphenol-aldehyde resin with alkoxy groups. This is performed through reaction of the alkylphenol-aldehyde resin with an alkylene oxide so as to result in an alkoxide functional group in place of the hydroxyl group of the phenol ring (of the alkylphenol component) to produce an alkoxy alkylphenol-aldehyde resin. This may be carried out in any way known in the field of alkoxylation of phenol compounds or resins. Suitable alkoxide functional groups include —OCH₂CH₃, —OCH₂CH₂CH₃, —OCH₂CH₂CH₂CH₃, or combinations thereof. The degree of alkoxylation influences the oil/water solubility and will impact performance and is often expressed in terms of wt % alkoxylation or mol % alkoxylation. The wt % alkoxylation, calculated by dividing the weight of the alkylene oxide reacted by the weight of the alkylphenol compound, can range from 1-45%. The mol % alkoxylation, calculated by dividing the number of moles of the alkylene oxide reacted by the number of moles of the alkylphenol compound, can range from 1-100%, 20-87% or even 25-35%.

A method of breaking an emulsion in a fluid produced from a subterranean formation includes a step of contacting an emulsion breaker with the produced fluid, wherein the emulsion breaker includes the alkoxy alkylphenol-aldehyde resin. In one aspect, a crude oil emulsion or crude oil wash water emulsion containing water soluble salts (such as brackish chloride salts of Na, K, Ca, and Mg) and crude oil hydrocarbons (including asphaltenes), prior to exposure to an electric field in an electric desalter, is treated with an emulsion breaker composition including the alkylphenol-formaldehyde resin.

While the amount of the alkoxy alkylphenol-aldehyde resin (in the emulsion breaker composition) that is contacted with the produced water may vary, the alkoxy alkylphenol-aldehyde resin is contacted with the produced fluid in an amount in a range of from about 1 ppmw to about 10,000 ppmw (in terms of wt, resin/wt, produced fluid); alternatively, in an amount in a range of from about 2.5 ppmw to about 1,000 ppmw.

### Additional Components

The disclosed resins can be used in compositions having additional components. Additional components include a corrosion inhibitor, a phosphate ester, monomeric or oligomeric fatty acids, solvents, asphaltene inhibitors, paraffin inhibitors, scale inhibitors, emulsifiers, water clarifiers, dispersants, emulsion breakers, hydrogen sulfide scavengers, gas hydrate inhibitors, biocides, pH modifiers, surfactants, functional agents and other additives, or combinations thereof.

### Corrosion Inhibitors

A resin disclosed herein can be used in a composition that can additionally include one or more corrosion inhibitors. Corrosion inhibitors can include a quaternary ammonium compound, an imidazoline derivative, an organic sulfur compound, or combinations thereof. Quaternary ammonium compounds can include tetramethyl ammonium chloride, tetraethyl ammonium chloride, tetrapropyl ammonium chloride, tetrabutyl ammonium chloride, tetrahexyl ammonium chloride, tetraoctyl ammonium chloride, benzyltrimethyl ammonium chloride, benzyltriethyl ammonium chloride, phenyltrimethyl ammonium chloride, phenyltrimethyl ammonium chloride, cetyl benzyldimethyl ammonium chloride, hexadecyl trimethyl ammonium chloride, dimethyl alkyl benzyl quaternary ammonium compounds, monomethyl dialkyl benzyl quaternary ammonium compounds, trimethyl benzyl quaternary ammonium compounds, trialkyl benzyl quaternary ammonium compounds, or combinations thereof. Imidazoline derivatives can be selected from an imidazoline derived from a polyamine and a long chain fatty acid. Examples of the polyamine can include ethylene diamine (EDA), diethylene triamine (DETA), triethylene tetraamine (TETA), or combinations thereof. Organic sulfur compounds can include a thiol (also known as a mercaptan), an organic disulfide, or combinations thereof.

### Phosphate Esters

In aspects, the resins disclosed herein can be used in compositions that can include mono-, di- or tri-alkyl or alkylaryl phosphate esters; phosphate esters of hydroxylamines; phosphate esters of polyols, or combinations thereof.

Suitable mono-, di- and tri-alkyl phosphate esters, mono-, di- and tri-alkylaryl phosphate esters, and phosphate esters of mono-, di-, and tri-ethanolamine typically contain from 1 to about 18 carbon atoms. In some aspects, the mono-, di- and trialkyl phosphate esters, mono-, di- and tri-alkylaryl phosphate esters, and mono-, di- and tri-arylalkyl phosphate esters are those prepared by reacting a C₃-C₁₈ aliphatic alcohol with phosphorous pentoxide. The phosphate intermediate interchanges its ester groups with triethyl phosphate with triethylphosphate producing a broader distribution of alkyl phosphate esters. Alternatively, the phosphate ester may be made by admixing with an alkyl diester, a mixture of low molecular weight alkyl alcohols or diols. The low molecular weight alkyl alcohols or diols preferably include C₆ to C₁₀ alcohols or diols. Further, phosphate esters of polyols and their salts containing one or more 2-hydroxyethyl groups, and hydroxylamine phosphate esters obtained by reacting polyphosphoric acid or phosphorus pentoxide with hydroxylamines such as diethanolamine or triethanolamine are preferred.

### Monomeric and Oligomeric Fatty Acid

The resins disclosed herein can be used in compositions that can further include a monomeric or oligomeric fatty acid. Preferred are C₁₄-C₂₂ saturated and unsaturated fatty acids as well as dimer, trimer and oligomer products obtained by polymerizing one or more of such fatty acids.

### Solvents

The resins disclosed herein can be used in compositions that can further include one or more solvents. Examples of solvents include, but are not limited to, water, alcohols, hydrocarbons, ketones, ethers, aromatics, amides, nitriles, sulfoxides, esters, glycol ethers, aqueous systems, and combinations thereof. In certain embodiments, the solvent is water, isopropanol, methanol, ethanol, 2-ethylhexanol, heavy aromatic naphtha, toluene, ethylene glycol, ethylene glycol monobutyl ether (EGMBE), diethylene glycol monoethyl ether, xylene, or combinations thereof. Representative polar solvents suitable for formulation with the composition include water, brine, seawater, alcohols (including straight chain or branched aliphatic such as methanol, ethanol, propanol, isopropanol, butanol, 2-ethylhexanol, hexanol, octanol, decanol, 2-butoxyethanol, etc.), glycols and derivatives (ethylene glycol, 1,2-propylene glycol, 1,3-propylene glycol, ethylene glycol monobutyl ether, etc.), ketones (cyclohexanone, diisobutylketone), N-methylpyrrolidinone (NMP), N,N-dimethylformamide, or combinations thereof. Representative non-polar solvents suitable for formulation with the composition include aliphatic hydrocarbons such as pentane, hexane, cyclohexane, methylcyclohexane, heptane, decane, dodecane, diesel, or combinations thereof; aromatic hydrocarbons such as toluene, xylene, heavy aromatic naphtha, fatty acid derivatives (acids, esters, amides), or combinations thereof; or any combination of aliphatic hydrocarbons and aromatic hydrocarbons.

In certain embodiments, the solvent is a polyhydroxylated solvent, a polyether, an alcohol, or a combination thereof. In certain embodiments, the solvent is monoethyleneglycol, methanol, dimethyl sulfoxide (DMSO), dimethylformamide (DMF), tetrahydrofuran (THF), or a combination thereof.

A resin disclosed herein can be used in compositions that may comprise from 0 wt % to 99 wt %; alternatively, from 1 wt % to 98 wt % of one or more solvents, based on total weight of the composition. In certain embodiments, a resins disclosed herein can be used in a composition that can include 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, or 95 wt % of one or more solvents, based on total weight of the composition. In certain embodiments, a resin disclosed herein can be used in a composition that comprises 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, or 99 wt % of one or more solvents, based on total weight of the composition.

### Asphaltene Inhibitors

The resin disclosed herein can be used in a composition that can additionally include another asphaltene inhibitor. Examples of asphaltene inhibitors include, but are not limited to, aliphatic sulphonic acids; alkyl aryl sulphonic acids; aryl sulfonates; lignosulfonates; alkylphenol/aldehyde resins and similar sulfonated resins; polyolefin esters; polyolefin imides; polyolefin esters with alkyl, alkylenephenyl or alkylenepyridyl functional groups; polyolefin amides; polyolefin amides with alkyl, alkylenephenyl or alkylenepyridyl functional groups; polyolefin imides with alkyl, alkylenephenyl or alkylenepyridyl functional groups; alkenyl/vinyl pyrrolidone copolymers; graft polymers of polyolefins with maleic anhydride or vinyl imidazole; hyperbranched polyester amides; polyalkoxylated asphaltenes, amphoteric fatty acids; salts of alkyl succinates; sorbitan monooleate; and polyisobutylene succinic anhydride, or combinations thereof.

### Paraffin Inhibitors

The resin disclosed herein can be used in a composition that can additionally include one or more paraffin inhibitors. Examples of paraffin inhibitors include, but are not limited to, paraffin crystal modifiers, and dispersant/crystal modifier combinations. Examples of paraffin crystal modifiers include, but are not limited to, alkyl acrylate copolymers, alkyl acrylate vinylpyridine copolymers, ethylene vinyl acetate copolymers, maleic anhydride ester copolymers, branched polyethylenes, naphthalene, anthracene, microcrystalline wax, asphaltenes, or combinations thereof. Examples of dispersants include, but are not limited to, dodecyl benzene sulfonate, oxyalkylated alkylphenols, and oxyalkylated alkylpenolic resins, or combinations thereof.

### Scale Inhibitors

The resin disclosed herein can be used in a composition that can additionally include one or more scale inhibitors. Examples of scale inhibitors include, but are not limited to, phosphates, phosphate esters, phosphoric acids, phosphonates, phosphonic acids, polyacrylamides, salts of acrylamido-methyl propane sulfonate/acrylic acid copolymer (AMPS/AA), phosphinated maleic copolymer (PHOS/MA), salts of a polymaleic acid/acrylic acid/acrylamido-methyl propane sulfonate terpolymer (PMA/AMPS), or combinations thereof.

### Emulsifiers

The resin disclosed herein can be used in a composition that can additionally include one or more emulsifier. Examples of emulsifiers include, but are not limited to, salts of carboxylic acids, products of acylation reactions between carboxylic acids or carboxylic anhydrides and amines, alkyl-, acyl-, and amide derivatives of saccharides (alkyl-saccharide emulsifiers), or combinations thereof.

### Water Clarifiers

The resin disclosed herein can be used in a composition that can include one or more water clarifiers. Examples of water clarifiers include, but are not limited to, inorganic metal salts such as alum, aluminum chloride, and aluminum chlorohydrate; organic polymers such as acrylic acid based polymers; acrylamide based polymers; polymerized amines; alkanolamines; thiocarbamates; cationic polymers such as diallyldimethylammonium chloride (DADMAC); or combinations thereof.

### Dispersants

The resin disclosed herein can be used in a composition that can additionally include one or more dispersants. Examples of dispersants include, but are not limited to, aliphatic phosphonic acids with 2 to 50 carbon atoms (e.g., hydroxyethyl diphosphonic acid), aminoalkyl phosphonic acids (e.g. polyaminomethylene phosphonates with 2 to 10 N atoms, for example, each bearing at least one methylene phosphonic acid group), or combinations thereof. Examples of polyaminomethylene phosphonates are ethylenediamine tetra(methylene phosphonate), diethylenetriamine penta(methylene phosphonate), triamine- and tetramine-polymethylene phosphonates with 2-4 methylene groups between each N atom, at least 2 of the numbers of methylene groups in each phosphonate being different, or combinations thereof. Other dispersants can include lignin or derivatives of lignin such as lignosulfonate and naphthalene sulfonic acid and derivatives.

### Emulsion Breakers

The alkoxy alkylphenol-aldehyde resin disclosed herein can be used in a composition that can additionally include one or more other emulsion breakers. Examples of emulsion breakers include, but are not limited to, dodecylbenzylsulfonic acid (DDBSA), the sodium salt of xylenesulfonic acid (NAXSA), epoxylated and propoxylated compounds, anionic cationic and nonionic surfactants, resins such as phenolic resins and epoxide resins, or combinations thereof.

### Hydrogen Sulfide Scavengers

The resin disclosed herein can be used in a composition that can additionally include one or more hydrogen sulfide scavengers. Examples of additional hydrogen sulfide scavengers include, but are not limited to, oxidants (e.g., inorganic peroxides such as sodium peroxide, or chlorine dioxide), aldehydes (e.g., of 1 to 10 carbon atoms such as formaldehyde or glutaraldehyde or (meth)acrolein), triazines (e.g., monoethanol amine triazine, monomethylamine triazine, and triazines from multiple amines or mixtures thereof), glyoxal, or combinations thereof.

### Gas Hydrate Inhibitors

The resin disclosed herein can be used in a composition that can additionally include one or more gas hydrate inhibitors. Examples of gas hydrate inhibitors include, but are not limited to, thermodynamic hydrate inhibitors (THI), kinetic hydrate inhibitors (KHI), anti-agglomerates (AA), or combinations thereof.

Examples of thermodynamic hydrate inhibitors include, but are not limited to, NaCl salt, KCl salt, CaCl₂ salt, MgCl₂ salt, NaBr₂ salt, formate brines (e.g. potassium formate), polyols (e.g., glucose, sucrose, fructose, maltose, lactose, gluconate, monoethylene glycol, diethylene glycol, triethylene glycol, mono-propylene glycol, dipropylene glycol, tripropylene glycols, tetrapropylene glycol, monobutylene glycol, dibutylene glycol, tributylene glycol, glycerol, diglycerol, triglycerol, sugar alcohols (e.g. sorbitol, mannitol), or combinations thereof), methanol, propanol, ethanol, glycol ethers (e.g., diethyleneglycol monomethylether, ethyleneglycol monobutylether, or combinations thereof), alkyl or cyclic esters of alcohols (e.g., ethyl lactate, butyl lactate, methylethyl benzoate, or combinations thereof), or combinations thereof.

Examples of kinetic hydrate inhibitors and anti-agglomerates include, but are not limited to, polymers and copolymers, polysaccharides (e.g., hydroxy-ethylcellulose (HEC), carboxymethylcellulose (CMC), starch, starch derivatives, xanthan, or combinations thereof), lactams (e.g., polyvinylcaprolactam, polyvinyl lactam), pyrrolidones (e.g., polyvinyl pyrrolidone of various molecular weights), surfactants (e.g., fatty acid salts, ethoxylated alcohols, propoxylated alcohols, sorbitan esters, ethoxylated sorbitan esters, polyglycerol esters of fatty acids, alkyl glucosides, alkyl polyglucosides, alkyl sulfates, alkyl sulfonates, alkyl ester sulfonates, alkyl aromatic sulfonates, alkyl betaine, alkyl amido betaines, or combinations thereof), hydrocarbon based dispersants (e.g., lignosulfonates, iminodisuccinates, polyaspartates, or combinations thereof), amino acids, proteins, or combinations thereof.

### Biocides

The resin disclosed herein can be used in a composition that can additionally include one or more biocides.

Examples of biocides include, but are not limited to, oxidizing and non-oxidizing biocides. Examples of non-oxidizing biocides include, for example, aldehydes (e.g., formaldehyde, glutaraldehyde, acrolein, or combinations thereof), amine-type compounds (e.g., quaternary amine compounds, cocodiamine, or a combination thereof), halogenated compounds (e.g., bronopol, 2-2-dibromo-3-nitrilopropionamide (DBNPA), or a combination thereof), sulfur compounds (e.g., isothiazolone, carbamates, metronidazole, or a combination thereof), quaternary phosphonium salts (e.g., tetrakis(hydroxymethyl)phosphonium sulfate (THPS)), or combinations thereof.

Examples of biocides oxidizing include sodium hypochlorite, trichloroisocyanuric acids, dichloroisocyanuric acid, calcium hypochlorite, lithium hypochlorite, chlorinated hydantoins, stabilized sodium hypobromite, activated sodium bromide, brominated hydantoins, chlorine dioxide, ozone, peroxides, or combinations thereof.

### pH Modifiers

The resin disclosed herein can be used in a composition that can additionally include one or more pH modifiers. Examples of pH modifiers include, but are not limited to, alkali hydroxides, alkali carbonates, alkali bicarbonates, alkaline earth metal hydroxides, alkaline earth metal carbonates, alkaline earth metal bicarbonates, or combinations thereof. Exemplary pH modifiers include NaOH, KOH, Ca(OH)₂, CaO, Na₂CO₃, KHCO₃, K₂CO₃, NaHCO₃, MgO, and Mg(OH)₂, or combinations thereof.

### Surfactants

The resin disclosed herein can be used in a composition that can additionally include one or more surfactants. Examples of surfactants include, but are not limited to, anionic surfactants, cationic surfactants, zwitterionic surfactants, and nonionic surfactants.

Anionic surfactants include alkyl aryl sulfonates, olefin sulfonates, paraffin sulfonates, alcohol sulfates, alcohol ether sulfates, alkyl carboxylates, alkyl ether carboxylates, alkyl phosphate esters, ethoxylated alkyl phosphate esters, and mono- and di-alkyl sulfosuccinates, mono- and di-alkyl sulfosuccinamates, or combinations thereof.

Cationic surfactants include alkyl trimethyl quaternary ammonium salts, alkyl dimethyl benzyl quaternary ammonium salts, dialkyl dimethyl quaternary ammonium salts, imidazolinium salts, or combinations thereof.

Nonionic surfactants include alcohol alkoxylates, alkylphenol alkoxylates, block copolymers of ethylene, propylene and butylene oxides, alkyl dimethyl amine oxides, alkyl-bis(2-hydroxyethyl) amine oxides, alkyl amidopropyl dimethyl amine oxides, alkylamidopropyl-bis(2-hydroxyethyl) amine oxides, alkyl polyglucosides, polyalkoxylated glycerides, sorbitan esters and polyalkoxylated sorbitan esters, alkyl polyethylene glycol esters and diesters, or combinations thereof. Examples of nonionic surfactants also include betaines, sultanes, amphoteric surfactants (e.g., alkyl amphoacetates and amphodiacetates, alkyl amphopropripionates and amphodipropionates, alkyliminodiproprionate, or combinations thereof), or combinations thereof.

In some aspect, a surfactant may be a quaternary ammonium compound, an amine oxide, an ionic or non-ionic surfactant, or any combination thereof. Suitable quaternary amine compounds include, but are not limited to, alkyl benzyl ammonium chloride, benzyl cocoalkyl(C₁₂-C₁₈)dimethylammonium chloride, dicocoalkyl (C₁₂-C₁₈)dimethylammonium chloride, ditallow dimethylammonium chloride, di(hydrogenated tallow alkyl)dimethyl quaternary ammonium methyl chloride, methyl bis(2-hydroxyethyl cocoalkyl (C₁₂-C₁₈) quaternary ammonium chloride, dimethyl (2-ethyl) tallow ammonium methyl sulfate, n-dodecylbenzyldimethylammonium chloride, n-octadecylbenzyldimethyl ammonium chloride, n-dodecyltrimethylammonium sulfate, soya alkyltrimethylammonium chloride, and hydrogenated tallow alkyl (2-ethylhexyl) dimethyl quaternary ammonium methyl sulfate.

### Functional Agents and Other Additives

The resins disclosed herein can be used in a composition that may further include additional functional agents or additives that provide a beneficial property. For example, additional agents or additives may be selected from the group consisting of pH adjusters or other neutralizing agents, surfactants, emulsifiers, sequestrants, solubilizers, other lubricants, buffers, detergents, cleaning agent, rinse aid composition, secondary anti-corrosion agent, preservatives, binders, thickeners or other viscosity modifiers, processing aids, carriers, water-conditioning agents, foam inhibitors or foam generators, threshold agent or system, aesthetic enhancing agent (i.e., dye, odorant, perfume), other agents or additives suitable for formulation with a resin disclosed herein and the like, and mixtures thereof. Additional agents or additives will vary according to the particular composition being manufactured.

The resin disclosed herein can be used in a composition that may further include additional functional agents or additives that provide a beneficial property. Additional agents or additives will vary according to the particular composition being manufactured and its intended use as one skilled in the art will appreciate. According to one embodiment, the compositions do not contain any of the additional agents or additives.

### Concentration of Additional Components

A resin disclosed herein can be used in a composition that may comprise from 0 wt % to 80 wt %, 0 wt % to 60 wt %, or 0 wt % to 50 wt % of one or more additional components, based on total weight of the composition. In some aspects, a resin disclosed herein can be used in a composition that can have at least 1.0 wt %, 1.5 wt %, 2.0 wt %, 2.5 wt %, 3.0 wt %, 3.5 wt %, 4.0 wt %, 4.5 wt %, 5.0 wt %, 5.5 wt %, 6.0 wt %, 6.5 wt %, 7.0 wt %, 7.5 wt %, 8.0 wt %, 8.5 wt %, 9.0 wt %, 9.5 wt %, 10.0 wt %, 10.5 wt %, 11.0 wt %, 11.5 wt %, 12.0 wt %, 12.5 wt %, 13.0 wt %, 13.5 wt %, 14.0 wt %, 14.5 wt %, or 15.0 wt % of one or more additional components, based on total weight of the composition; and less than 80, 79, 78, 77, 76, 75, 74, 73, 72, 71, 70, 69, 68, 67, 66, 65, 64, 63, 62, 61, or 60 wt % of the one or more additional components based on total weight of the composition.

### Examples

The following examples are intended to illustrate different aspects and embodiments of the disclosure and are not to be considered limiting. It will be recognized that various modifications and changes may be made to the experimental embodiments described herein, and without departing from the scope of the claims.

The raw materials used in the Examples are listed in Table I.

TABLE I
Raw Materials Used in the Examples

| Material # | CAS # |
|---|---|
| Nonylphenol | 84852-15-3 |
| Dodecylsulfonic acid (DDBSA) | 68584-22-5 |
| Vanillin | 121-33-5 |
| Paraformaldehyde | 30525-89-4 |
| Ethylene oxide | 75-21-8 |
| Propylene oxide | 75-56-9 |
| Heavy aromatic naphtha (HAN) | |
| Kerosene | |

Example 1: The impact by the mol % of vanillin in the reaction mixture upon non-volatile residue (NVR), molecular weight, and PDI of the synthesized alkylphenol-aldehyde resins was studied. A variety of nonylphenol-aldehyde resins were synthesized using anywhere from 0-1 mol % of vanillin with a balance of the aldehyde reactant being paraformaldehyde. Each of the synthesized resin samples were tested to determine NVR via thermogravimetric analysis (TGA), Mn, Mw, and PDI.

As seen in Table II, each of the determined values are listed in order of mol % of vanillin in the reaction mixture.

TABLE II
properties of synthesized resins by
wt % of vanillin in reaction mixture

| | Mol % | | | | | |
|---|---|---|---|---|---|---|
| | paraform- | Mol % | | | | |
| | aldehyde | vanillin in | | | | |
| | in reaction | reaction | | | | |
| Sample | mixture | mixture | NVR | Mn | Mw | PDI |
| 7015-195 | 0 | 1.00 | not | 1493 | 2353 | 1.6 |
| | | | determined | | | |
| 7015-199 | 0.25 | 0.75 | 82.4 | 1986 | 3839 | 1.9 |
| 7015-200 | 0.50 | 0.50 | 83.9 | 1801 | 3460 | 1.9 |
| 7103-3 | 0.75 | 0.25 | 85.2 | 2068 | 4221 | 2.0 |
| 7103-4 | 1.00 | 0 | 64.2 | 502 | 573 | 1.1 |

As seen in Table II, the amount of vanillin in the reaction mixture significantly influences the properties of the synthesized resin. We expect that it will have a corresponding influence upon the alkoxy alkylphenol-aldehyde resin.

Example 2: In Example 2, renewable alkylphenol-aldehyde resins were synthesized using nonylphenol to form the alkylphenol component, paraformaldehyde to form the synthetic aldehyde component, and vanillin to form the natural aldehyde component of the resins. The renewable alkylphenol-aldehyde resins in Example 2 were thus nonylphenol-paraformaldehyde/vanillin resins.

The impact upon reaction time, during a high temperature hold, upon the properties of the synthesized resin was studied. A variety of nonylphenol-paraformaldehyde/vanillin resins were synthesized using high temperature hold times ranging from 1.5-3.5 hrs.

300 g (1.361 mol) of nonylphenol, 16.83 g (0.511 mol) of paraformaldehyde, and 132.0 g of kerosene were initially charged to a four-necked round bottom flask. As will be seen in the following description, the aforementioned amount of nonylphenol corresponds to 50 wt % of the overall reaction mixture. The flask contents were stirred and heated to 65° C., and 4.74 g (0.007 mol) of a 50 wt % mixture of dodecylsulfonic acid in kerosene was charged, drop-wise, into the flask. An exotherm temperature rise to 95° C. was observed.

Upon cooling the flask contents to 65° C., a first addition of vanillin (in the amount of 51.78 g-0.340 mol) was charged to the flask. After 15 minutes, a second addition of vanillin (in the amount of 16.83 g-0.511 mol) was charged to the flask. In contrast to the exotherm that is usually experienced by the dodecylsulfonic acid-catalyzed reaction of paraformaldehyde with the nonylphenol, no exotherm was observed after the additions of the vanillin. The contents of the flask were then heated to 95° C. and then held at that temperature for 1 hr (corresponding to a low temperature hold). The temperature of the contents of the flask was then ramped up, over a period of 2 hr, to a temperature of 180° C. (corresponding to a high temperature hold).

Samples of the flask contents were withdrawn after 1.5 hr of the high hold temperature, after 2.5 hr of the high hold temperature, and after 3.5 hr of the high hold temperature. The Mz, Mw, Mn, and PDI of the samples were obtained. As seen in the molecular weights and PDI listed in Table III, a longer high temperature hold produces higher molecular weight resins.

TABLE III
impact of high temperature hold time upon
molecular weights and PDI of resin

| | High temperature | | | | |
|---|---|---|---|---|---|
| Sample # | hold time (hr) | Mz (Da) | Mw (Da) | Mn (Da) | PDI |
| TC018172 | 1.5 | 4156 | 2755 | 1718 | 1.6 |
| TC018173 | 2.5 | 6229 | 3852 | 2111 | 1.8 |
| TC018174 | 3.5 | 8935 | 5104 | 2472 | 2.1 |

Example 3: In Example 3, more renewable alkylphenol-aldehyde resins were synthesized using nonylphenol to form the alkylphenol component, paraformaldehyde to form the synthetic aldehyde component, and vanillin to form the natural aldehyde component of the resins. The renewable alkylphenol-aldehyde resins in Example 3 were thus nonylphenol-paraformaldehyde/vanillin resins. In contrast to the renewable alkylphenol-aldehyde resins of Example 2, the renewable alkylphenol-aldehyde resins of Example 3 were synthesized using a relatively higher amount of vanillin and a relatively lower amount of paraformaldehyde.

The impact upon reaction time, during a high temperature hold, upon the properties of the synthesized resin was studied. A variety of nonylphenol-paraformaldehyde/vanillin resins were synthesized using high temperature hold times ranging from 1.5-3.5 hrs.

300 g (1.361 mol) of nonylphenol, 11.2 g (0.374 mol) of paraformaldehyde, and 132.0 g of kerosene were initially charged to a four-necked round bottom flask. As will be seen in the following description, the aforementioned amount of nonylphenol corresponds to 50 wt % of the overall reaction mixture. The flask contents were stirred and heated to 65° C., and 4.74 g of a 50 wt % mixture of dodecylsulfonic acid in kerosene was charged (corresponding to 0.007 mol of dodecylsulfonic acid), drop-wise, into the flask. An exotherm temperature rise to 95° C. was observed. Upon cooling the flask contents to 65° C., a first addition of vanillin (in the amount of 103.55 g-0.681 mol) was charged to the flask. After 15 minutes, a second addition of vanillin (in the amount of 11.22 g-0.0737 mol) was charged to the flask. In contrast to the exotherm normally found with dodecylsulfonic acid-catalyzed reaction of paraformaldehyde with the nonylphenol, no exotherm was observed after the additions of the vanillin. The contents of the flask were then heated to 95° C. and then held at that temperature for 1 hr (corresponding to a low temperature hold). The temperature of the contents of the flask was then ramped up, over a period of 2 hr, to a temperature of 180° C. (corresponding to a high temperature hold).

Samples of the flask contents were withdrawn after 1.5 hr of the high hold temperature, after 2.5 hr of the high hold temperature, and after 3.5 hr of the high hold temperature. The Mz, Mw, Mn, and PDI of the samples were obtained. As seen in the molecular weights and PDI listed in Table IV, a longer high temperature hold produces higher molecular weight resins.

TABLE IV
impact of high temperature hold time upon
molecular weights and PDI of resin

| | High temperature | | | | |
|---|---|---|---|---|---|
| Sample # | hold time (hr) | Mz (Da) | Mw (Da) | Mn (Da) | PDI |
| TC018175 | 1.5 | 2633 | 1791 | 1208 | 1.6 |
| TC018176 | 2.5 | 4033 | 2546 | 1517 | 1.8 |
| TC018177 | 3.5 | 6855 | 3997 | 2017 | 2.1 |

Example 4: In Example 4, renewable alkylphenol-aldehyde resins were alkoxylated to form renewable alkoxy alkylphenol-aldehyde resins having various degrees of alkoxylation. The renewable alkoxy alkylphenol-aldehyde resins had an ethoxy component as the alkoxy component, a nonylphenol component as the alkylphenol component, paraformaldehyde component as the synthetic aldehyde component, and vanillin as the natural aldehyde component.

The impact of the degree of alkoxylation (ethoxylation) upon the performance of the synthesized resins as emulsion breakers was studied. Each of the samples of nonylphenol-paraformaldehyde/vanillin resins of Example 1 (Sample numbers 7103-3, 7015-199, 7015-200, and 7015-195) was portioned out and each portion (within a given sample) was ethoxylated to a differing degree of ethoxylation.

Table V lists the degree of ethoxylation by sample number. In Table V, each of the ethoxylated lots is identified with the same sample number from Example 1 and also appended with the prefix HOU-. In other words, the ethoxylated resin of Sample number 7103-3 from Example 1 is provided with lot #HOU-7103-3. Each degree of ethoxylation reported in Table V was determined by dividing the molar amount of ethylene oxide used during ethoxylation of the resins by the molar amount of nonylphenol used during synthesis of the resins, then multiplied by 100%.

TABLE V
list of differently ethoxylated samples

| HOU-7103-3: | HOU-7015-199: | HOU-7015-200: | HOU-7015-195: |
|---|---|---|---|
| Ethoxylation | Ethoxylation | Ethoxylation | Ethoxylation |
| (sample #) | (sample #) | (sample #) | (sample #) |
| 28% (7264-62) | 29% (7264-73) | 32% (7264-98) | 20% (7264-110) |
| 33% (7264-63) | 35% (7264-74) | 38% (7264-99) | 25% (7264-111) |
| 39% (7264-65) | 42% (7264-75) | 44% (7264-100) | 30% (7264-112) |
| 50% (7264-66) | 45% (7264-76) | 49% (7264-101) | 35% (7264-113) |
| 63% (7264-67) | 50% (7264-77) | 55% (7264-102) | 40% (7264-114) |
| 75% (7264-68) | 55% (7264-78) | 60% (7264-103) | 45% (7264-115) |
| 83% (7264-69) | 60% (7264-79) | 65% (7264-104) | 50% (7264-116) |
| 87% (7264-70) | 65% (7264-80) | 69% (7264-105) | 55% (7264-117) |
| | 69% (7264-81) | 74% (7264-106) | 60% (7264-118) |
| | 73% (7264-82) | 77% (7264-107) | 65% (7264-119) |
| | 77% (7264-83) | 81% (7264-108) | 70% (7264-120) |
| | 82% (7264-83) | 85% (7264-109) | 75% (7264-121) |

Each of the ethoxylated samples was evaluated as an emulsion breaker via the portable electric desalter test. We determined that ethoxylation percentages of 25-35 wt % yielded the best performance on the electric desalter test.

Example 5: The effect of the vanillin content upon performance of the synthesized resin as an asphaltene inhibitor was studied. Each of the nonylphenol-paraformaldehyde/vanillin resins of Example 1 was evaluated using Ebano Oil at 1000 ppm at 40° C. As seen in the plots of the FIG., sample #7103-3 yielded the best performance as an asphaltene inhibitor. The 7103-3 resins were characterized as having the highest molecular weight of the nonylphenol-paraformaldehyde/vanillin resins of Example 1. For the resins, we can thus say that the higher the molecular weight, the better performance as an asphaltene inhibitor. We believe that resins having Mw in a range of 2,000 to 4,500 Daltons perform well as an asphaltene inhibitor.

### Additional Description

Clause 1. A method for synthesizing an alkylphenol-aldehyde resin, the method comprising: reacting an alkylphenol compound with a natural aldehyde compound to produce the alkylphenol-aldehyde resin.
Clause 2. The method of clause 1, wherein the natural aldehyde is selected from vanillin, cinnamaldehyde, furfural, or combinations thereof.
Clause 3. The method of clause 1 or 2, further comprising: reacting the alkylphenol compound with a first amount of a synthetic aldehyde to produce the alkylphenol-aldehyde resin.
Clause 4. The method of clause 3, wherein the reacting the alkylphenol compound with the first amount of the synthetic aldehyde is performed prior to reacting the alkylphenol compound with the natural aldehyde compound.
Clause 5. The method of clause 4, further comprising: reacting the alkylphenol compound with a second amount of the synthetic aldehyde to produce the alkylphenol-aldehyde resin.
Clause 6. The method of clause 5, wherein the reacting the alkylphenol compound with the second amount of the synthetic aldehyde is performed after reacting the alkylphenol compound with the natural aldehyde compound.
Clause 7. The method of any one of clauses 1 to 6, further comprising: reacting the alkylphenol-aldehyde resin with an alkoxide to produce an alkoxy alkylphenol-aldehyde resin.
Clause 8. The method of any one of clauses 1 to 7, wherein the alkylphenol-aldehyde resin comprises: an alkylphenol component; and an aldehyde component, wherein the aldehyde component comprises i) a natural aldehyde component, and optionally ii) a synthetic aldehyde component.
Clause 9. The method of clause 8, wherein the natural aldehyde component is present in an amount of from about 1 wt % to about 100 wt % based on a total weight of the aldehyde component.
Clause 10. The method of clause 8 or 9, wherein the synthetic aldehyde component is present in an amount of from 0 wt % to about 99 wt % based on a total weight of the aldehyde component.
Clause 11. The method of any one of clauses 8 to 10, wherein the natural aldehyde component is selected from a vanillin component, a cinnamaldehyde component, a furfural component, or combinations thereof.
Clause 12. The method of any one of clauses 8 to 11, wherein the alkylphenol component comprises methylphenol, tert-butylphenol (PTBP), sec-butylphenol, amylphenol, tert-hexylphenol, cyclohexylphenol, tert-octylphenol (PTOP), isooctylphenol, decylphenol, dodecylphenol, tetradecyl phenol, octadecylphenol, nonylphenol, pentadecylphenol, cetylphenol, or combinations thereof.
Clause 13. The method of any one of clauses 8 to 12, wherein a molar ratio of the alkylphenol component to the aldehyde component is 1:1.
Clause 14. An alkylphenol-aldehyde resin comprising: an alkylphenol component; and an aldehyde component, wherein the aldehyde component comprises i) a natural aldehyde component, and optionally ii) a synthetic aldehyde component.
Clause 15. The alkylphenol-aldehyde resin of clause 14, wherein the natural aldehyde component is present in an amount of from about 1 wt % to about 100 wt % based on a total weight of the aldehyde component.
Clause 16. The alkylphenol-aldehyde resin of clause 14 or claim 15, wherein the synthetic aldehyde component is present in an amount of from 0 wt % to about 99 wt % based on a total weight of the aldehyde component.
Clause 17. The alkylphenol-aldehyde resin of any one of clauses 14 to 16, wherein the natural aldehyde component is selected from a vanillin component, a cinnamaldehyde component, a furfural component, or combinations thereof.
Clause 18. The alkylphenol-aldehyde resin of any one of clauses 14 to 17, wherein the alkylphenol component comprises methylphenol, tert-butylphenol (PTBP), sec-butylphenol, amylphenol, tert-hexylphenol, cyclohexylphenol, tert-octylphenol (PTOP), isooctylphenol, decylphenol, dodecylphenol, tetradecyl phenol, octadecylphenol, nonylphenol, pentadecylphenol, cetylphenol, or combinations thereof.
Clause 19. The alkylphenol-aldehyde resin of any one of clauses 14 to 18, wherein a molar ratio of the alkylphenol component to the aldehyde component is 1:1.
Clause 20. The alkylphenol-aldehyde resin of any one of clauses 14 to 19, which is alkoxylated to form an alkoxy alkylphenol-aldehyde resin.
Clause 21. An alkoxy alkylphenol-aldehyde resin comprising: an alkylphenol component; an aldehyde component, wherein the aldehyde component comprises i) a natural aldehyde component, and optionally ii) a synthetic aldehyde component; and an alkoxy component.
Clause 22. A method of breaking an emulsion in a fluid produced from a subterranean formation, the method comprising: contacting an emulsion breaker with the fluid, wherein the emulsion breaker comprises the alkoxy alkylphenol-aldehyde resin of clause 20 or claim 21.
Clause 23. A method for asphaltene inhibition, the method comprising: contacting an asphaltene-containing hydrocarbon with an asphaltene inhibitor comprising the alkylphenol-aldehyde resin of any one of clauses 14 to 19.
Clause 24. A method for reducing viscosity of a hydrocarbon, the method comprising: contacting the hydrocarbon with a viscosity reducer comprising the alkylphenol-aldehyde resin of any one of clauses 14 to 19.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for synthesizing an alkylphenol-aldehyde resin, the method comprising:
reacting an alkylphenol compound with a natural aldehyde compound to produce the alkylphenol-aldehyde resin.

2. The method of claim 1, wherein the natural aldehyde compound is selected from vanillin, cinnamaldehyde, furfural, or combinations thereof.

3. The method of claim 1, further comprising:
reacting the alkylphenol compound with a first amount of a synthetic aldehyde to produce the alkylphenol-aldehyde resin.

4. The method of claim 3, wherein reacting the alkylphenol compound with the first amount of the synthetic aldehyde is performed prior to reacting the alkylphenol compound with the natural aldehyde compound.

5. The method of claim 4, further comprising:
reacting the alkylphenol compound with a second amount of the synthetic aldehyde to produce the alkylphenol-aldehyde resin.

6. The method of claim 5, wherein reacting the alkylphenol compound with the second amount of the synthetic aldehyde is performed after reacting the alkylphenol compound with the natural aldehyde compound.

7. The method of claim 1, further comprising:
reacting the alkylphenol-aldehyde resin with an alkoxide to produce an alkoxy alkylphenol-aldehyde resin.

8. The method of claim 1, wherein the alkylphenol-aldehyde resin comprises:
an alkylphenol component; and
an aldehyde component, wherein the aldehyde component comprises i) a natural aldehyde component, and optionally ii) a synthetic aldehyde component.

9. The method of claim 8, wherein the natural aldehyde component is present in an amount of from about 1 wt % to about 100 wt % based on a total weight of the aldehyde component.

10. The method of claim 8, wherein the synthetic aldehyde component is present in an amount of from 0 wt % to about 99 wt % based on a total weight of the aldehyde component.

11. The method of claim 8, wherein the natural aldehyde component is selected from a vanillin component, a cinnamaldehyde component, a furfural component, or combinations thereof.

12. The method of claim 8, wherein the alkylphenol component comprises methylphenol, tert-butylphenol (PTBP), sec-butylphenol, amylphenol, tert-hexylphenol, cyclohexylphenol, tert-octylphenol (PTOP), isooctylphenol, decylphenol, dodecylphenol, tetradecyl phenol, octadecylphenol, nonylphenol, pentadecylphenol, cetylphenol, or combinations thereof.

13. The method of claim 8, wherein a molar ratio of the alkylphenol component to the aldehyde component is 1:1.

14. An alkylphenol-aldehyde resin comprising:
an alkylphenol component; and
an aldehyde component, wherein the aldehyde component comprises a natural aldehyde component.

15. The alkylphenol-aldehyde resin of claim 14, wherein the natural aldehyde component is present in an amount of from about 1 wt % to about 100 wt % based on a total weight of the aldehyde component.

16. The alkylphenol-aldehyde resin of claim 14, wherein the aldehyde component further comprises a synthetic aldehyde component, wherein the synthetic aldehyde component is present in an amount of from 0 wt % to about 99 wt % based on a total weight of the aldehyde component.

17. The alkylphenol-aldehyde resin of claim 14, wherein the natural aldehyde component is selected from a vanillin component, a cinnamaldehyde component, a furfural component, or combinations thereof.

18. The alkylphenol-aldehyde resin of claim 17, wherein the alkylphenol component comprises methylphenol, tert-butylphenol (PTBP), sec-butylphenol, amylphenol, tert-hexylphenol, cyclohexylphenol, tert-octylphenol (PTOP), isooctylphenol, decylphenol, dodecylphenol, tetradecyl phenol, octadecylphenol, nonylphenol, pentadecylphenol, cetylphenol, or combinations thereof.

19. The alkylphenol-aldehyde resin of claim 14, wherein a molar ratio of the alkylphenol component to the aldehyde component is 1:1.

20. The alkylphenol-aldehyde resin of claim 14, further comprising an alkoxy component.
